(19) United States
(12) Patent Application Publication
(10) Pub. No.: US 2015/0120173 A1
(43) Pub. Date: Apr. 30, 2015

(54) SYSTEM AND METHOD FOR CONTROLLING A POWERTRAIN IN A VEHICLE

(71) Applicant: FORD GLOBAL TECHNOLOGIES, LLC, DEARBORN, MI (US)

(72) Inventor: Douglas Raymond Martin, Canton, MI (US)

(73) Assignee: FORD GLOBAL TECHNOLOGIES, LLC, DEARBORN, MI (US)

(21) Appl. No.: 14/068,014

(22) Filed: Oct. 31, 2013

(51) Int. Cl. F02D 28/00

(52) U.S. Cl. CPC F02D 28/00
USPC 701/110

(57) ABSTRACT

A system and method for controlling a powertrain in a vehicle includes a controller configured to control vehicle speed around a plurality of target vehicle speeds based on respective accelerator pedal positions. This control operates when the vehicle is operating outside of a constant speed control process. The current target vehicle speed can be used as a desired constant speed when the vehicle is operating within a constant speed control process.

### TECHNICAL FIELD

The present invention relates to a system and method for controlling the powertrain.

### BACKGROUND

One way of controlling a vehicle powertrain is by having an accelerator pedal mapped to wheel torque such that increased deflection of the pedal results in an increase in wheel torque. Because of various factors, including topography—e.g., the grade of the road on which the vehicle is traveling—wheel torque does not always relate well to vehicle speed. This can lead to the vehicle moving faster or more slowly than the vehicle operator expects, especially in hilly regions. For example, if the driver maintains a constant accelerator pedal position when the vehicle is going up a steep hill, the vehicle will slow down, despite the fact that maintaining the accelerator pedal in a constant position would intuitively indicate a constant vehicle speed. To overcome this aspect of torque control, the driver must press the pedal significantly to increase the wheel torque merely to keep the vehicle speed constant.

Similarly, if the driver maintains a constant accelerator pedal position when the vehicle is cresting a hill, the vehicle is likely to undergo a rapid acceleration; therefore as the vehicle begins its downward descent, the driver must lift off the accelerator pedal to maintain a desired vehicle speed. Although some vehicles may use speed control when operating within a constant speed control process, such as cruise control, it would be desirable to have a system and method for controlling a powertrain in vehicle that controls vehicle speed based on accelerator pedal position so as to provide the vehicle operator a more intuitive control during normal vehicle operation—i.e., outside of a cruise control or other constant speed control process.

### SUMMARY

At least some embodiments of the present invention include a method for controlling a powertrain in a vehicle. The method includes controlling vehicle speed around a plurality of target vehicle speeds based on respective accelerator pedal positions when the vehicle is operating outside of a constant speed control process. Embodiments of the method may further include using the current target vehicle speed as a desired constant speed when the vehicle is operating within a constant speed control process.

At least some embodiments of the present invention include a method for controlling a powertrain in a vehicle that includes controlling vehicle speed based on differences between current vehicle speeds and corresponding target vehicle speeds based on respective accelerator pedal positions when the vehicle is operating outside of a constant speed control process. Embodiments of the method may further include using the current target vehicle speed as a desired constant speed when the vehicle is operating within a constant speed control process.

At least some embodiments of the present invention include a control system for controlling a powertrain in a vehicle. The control system includes a controller configured to continuously control vehicle speed around a plurality of target vehicle speeds based on respective accelerator pedal positions when the vehicle is operating outside of a constant speed control process, and to use the current target vehicle speed as a desired constant speed when the vehicle is operating within a constant speed control process.

### BRIEF DESCRIPTION OF THE DRAWINGS

FIG. 1 shows a vehicle including a powertrain having a control system in accordance with embodiments of the present invention;

FIG. 2 shows a flowchart illustrating a method in accordance with embodiments of the present invention;

FIG. 3 shows a portion of a driver display in accordance with embodiments of the present invention; and

FIGS. 4A-4C show graphs indicating pedal position, vehicle velocity and driver demanded torque versus time, illustrating a control system and method in accordance with embodiments of the present invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

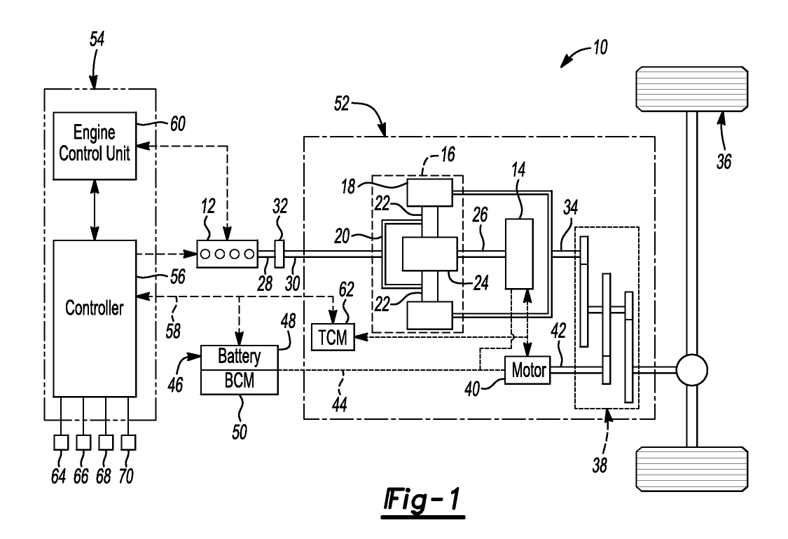

FIG. 1 is a schematic representation of a vehicle 10, which may include an engine 12 and an electric machine 14. The electric machine 14 may function as a motor, a generator, or both, although in this embodiment, it will be referred to as a generator. The engine 12 and the generator 14 may be connected through a power transfer arrangement, which in this embodiment, is a planetary gear arrangement 16. Of course, other types of power transfer arrangements, including other gear sets and transmissions, may be used to connect the engine 12 to the generator 14. The planetary gear arrangement 16 includes a ring gear 18, a carrier 20, planet gears 22, and a sun gear 24.

The generator 14 can also output torque to a shaft 26 connected to the sun gear 24. Similarly, the engine 12 can output torque to a crankshaft 28, which may be connected to a shaft 30 through a passive clutch 32. The clutch 32 may provide protection against over-torque conditions. The shaft 30 may be connected to the carrier 20 of the planetary gear arrangement 16, and the ring gear 18 may be connected to a shaft 34, which may be connected to a first set of vehicle drive wheels, or primary drive wheels 36 through a gear set 38.

The vehicle 10 may include a second electric machine 40, which may also function as a motor, a generator, or both, although in this embodiment, it will be referred to as a motor. The motor 40 can be used to output torque to a shaft 42 connected to the gear set 38. Other vehicles that can be used with embodiments of the present invention may have different electric machine arrangements, such as more or fewer than two electric machines. As noted above, the elements of the electric machine arrangement—i.e., the motor 40 and the generator 14—can be used as motors to output torque, or as generators, outputting electrical power to a high voltage bus 44 and to an energy storage system 46, which may include a battery pack 48 and a battery control module (BCM) 50.

The battery 48 may be a high voltage battery that is capable of outputting electrical power to operate the motor 40 and the generator 14. The BCM 50 may act as a controller for the battery 48. Other types of energy storage systems can be used with a vehicle, such as the vehicle 10. For example, a device such as a capacitor can be used, which, like a high voltage battery, is capable of both storing and outputting electrical energy. Alternatively, a device such as a fuel cell may be used in conjunction with a battery and/or capacitor to provide electrical power for the vehicle 10.

As shown in FIG. 1, the motor 40, the generator 14, the planetary gear arrangement 16, and a portion of the second gear set 38 may generally be referred to as a transmission 52. Although depicted as a powersplit device in FIG. 1, other HEV powertrain configurations may be employed, such as parallel or series HEVs. To control the engine 12 and components of the transmission 52—e.g., the generator 14 and motor 40—a vehicle control module 54, such as a powertrain control module (PCM), may be provided. The PCM 54 may include a vehicle system controller (VSC), shown generally as controller 56. Although it is shown as a single controller, the VSC 56 may include controllers that may be used to control multiple vehicle systems. The PCM 54 may include both software embedded within the VSC 56 and/or separate hardware to control various vehicle systems.

A controller area network (CAN) 58 may allow the VSC 56 to communicate with the transmission 52 and the BCM 50. Just as the battery 48 includes a BCM 50, other devices controlled by the VSC 56 may have their own controllers. For example, an engine control unit (ECU) 60 may communicate with the VSC 56 and may perform control functions on the engine 12. In addition, the transmission 52 may include a transmission control module (TCM) 62, configured to coordinate control of specific components within the transmission 52, such as the generator 14 and/or the motor 40. Some or all of these various controllers can make up a control system in accordance with the present invention. Although illustrated and described in the context of the vehicle 10, which is an HEV, it is understood that embodiments of the present invention may be implemented on other types of vehicles, such as conventional internal combustion engine driven vehicles, plug-in hybrid electric vehicles (PHEV) or those powered by an electric motor alone.

Also shown in FIG. 1 are simplified schematic representations of a braking system 64, an accelerator pedal 66, and a gear shifter 68. The braking system 64 may include such things as a brake pedal, position sensors, pressure sensors, or some combination thereof (not shown) as well as a mechanical connection to the vehicle wheels, such as the wheels 36, to effect friction braking. The braking system 64 may also include a regenerative braking system, wherein braking energy is captured and stored as electrical energy in the battery 48. Similarly, the accelerator pedal 66 may include one or more sensors, which like the sensors in the braking system 64, may communicate information to the VSC 56, such as accelerator pedal position, which may be in turn communicated to the ECU 60. The gear shifter 68 may also communicate with the VSC 56. For instance, the gear shifter may include one or more sensors for communicating the gear shifter position to the VSC 56. The vehicle 10 may also include a speed sensor 70 for communicating vehicle speed to the VSC 56.

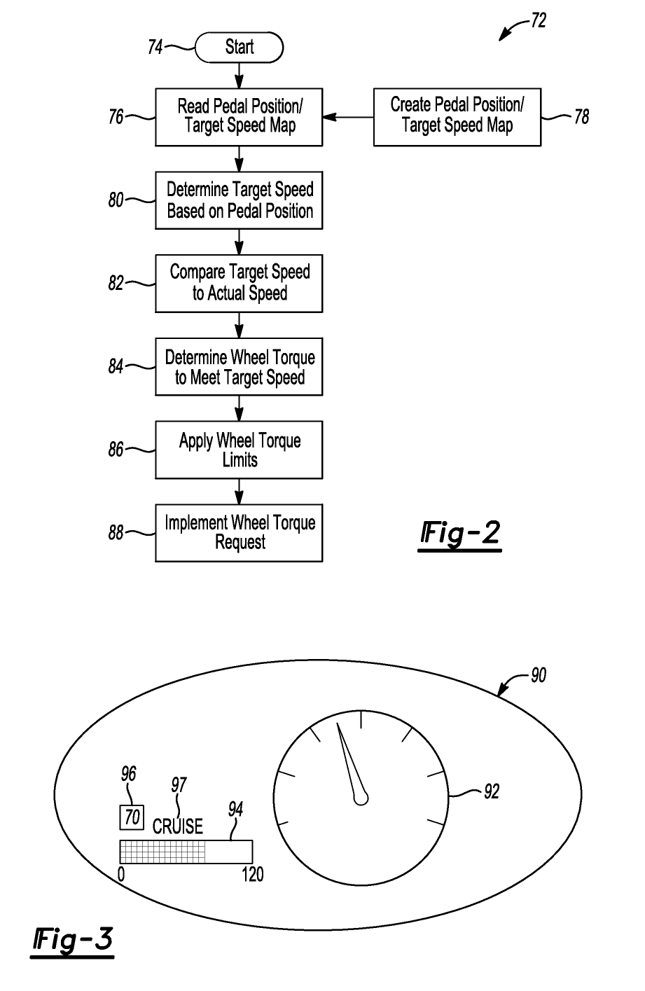

Turning now to FIG. 2, a flowchart 72 is shown illustrating a method in accordance with embodiments of the present invention. The flowchart 72 describes the method generally, while aspects of the method are described in greater detail below. The method starts at block 74 and moves to step 76, where the “Pedal Position/Target Speed Map” is read by the system. As used in this context, the “system” is the control system described above. In particular, a controller such as the ECU 60 may implement some or all of the steps illustrated in FIG. 2, although in other embodiments other controllers or combinations of controllers may perform these steps. The Pedal Position/Target Speed Map is a map of accelerator pedal position versus vehicle speed, which is shown in the flowchart 72 as being created at step 78. Such a map may be created by theoretical or empirical data and preprogrammed into a controller, such as the ECU 60. Mapping accelerator pedal position to vehicle speed facilitates generation of a respective target vehicle speeds based on actual accelerator pedal positions during vehicle operation.

At step 80, a determination is made as to the target vehicle speed based on the position of the accelerator pedal, such as the pedal 66 shown in FIG. 1. At step 82 the target speed is compared to the actual speed, and at step 84 a determination is made as to the wheel torque necessary to meet the target speed. The actual implementation of determining the wheel torque, such as shown at step 84, may proceed in a number of different ways; however, one effective way is to apply a PI (proportional integral) controller to the difference between the target speed and the actual speed determined at step 82. Although a PI controller is used in this embodiment, other types of proportional, integral, differential or other controllers may be used. Once the desired wheel torque is determined at step 84, it is compared to predetermined wheel torque limits at step 86, and if necessary, the desired wheel torque is clipped to ensure that it is not higher or lower than these limits. Once this is done, the wheel torque request is implemented at step 88.

The method illustrated in FIG. 2 and described above can be implemented when the vehicle is not in cruise control. To generalize, the method continuously controls the vehicle speed around a plurality of target vehicle speeds based on respective accelerator pedal positions when the vehicle is operating outside of a constant speed control process. This is a dynamic process that occurs during normal driving, and is therefore different from systems and methods that control vehicle speed based on a single constant speed setpoint. As shown generally at steps 82 and 84, the vehicle speed control is based on differences between current vehicle speeds and corresponding target vehicle speeds, which are based on respective accelerator pedal positions. Specifically, once the difference between current and target vehicle speed is determined, a required amount of wheel torque is applied to achieve the target.

Thus far, the embodiments of the present invention illustrated and described above were focused on operation of the vehicle outside of a constant speed control process, such as cruise control; however, embodiments of the present invention may also be advantageously applied to a cruise control or other constant speed control process. For example, actuating the accelerator pedal—whether by tipping-in or tipping-out—results in the determination of a target speed based on the pedal position. This was shown in step 80 in FIG. 2. Outside of a constant speed control process, the target speed is not assumed to be a constant speed, although the vehicle speed may be generally constant if the vehicle operator continues to hold the accelerator pedal in one position. Conversely, if the vehicle is in cruise control, embodiments of the present invention can use the current target vehicle speed as a desired constant speed.

An example of this feature is described as follows. In accordance with embodiments of the present invention as illustrated and described above, a target vehicle speed will be calculated when the accelerator pedal is actuated or released. When it is tipped-in, the vehicle will be controlled to accelerate toward the target. For illustrative purposes, the target vehicle speed will be assumed to be 70 mph. If, while the vehicle is accelerating toward the target of 70 mph, it is traveling at 50 mph when the “set” command is initiated in cruise control, a conventional system will attempt to maintain the vehicle speed at or near 50 mph. In contrast, embodiments of the present invention will use the target speed of 70 mph as the desired constant speed, and the vehicle will continue to accelerate to the target speed before being held constant by the speed control system. Thus, when the vehicle is operating within a constant speed control process, the current target vehicle speed is used as the desired constant speed—e.g., the cruise control setpoint.

In order to provide the driver with information regarding the target vehicle speed, embodiments of the present invention provide a plurality of indicators, at least one of which is configured to indicate the current target vehicle speed and the current vehicle speed—i.e., the current target vehicle speed and the current vehicle speed could be shown in the same indicator or they may be shown in separate indicators. This is illustrated in FIG. 3 where a portion of a vehicle dashboard display 90 is shown. The display 90 includes a speedometer 92, which illustrates the current vehicle speed, and also includes indicators 94, 96, both of which show the current target vehicle speed in different formats. Specifically, the indicator 94 shows the current target vehicle speed is a bar graph, while the indicator 96 shows the same parameter as a numerical value. Indicators such as these may be helpful to the vehicle operator, particularly when operating in a constant speed control process, such as cruise control—see “CRUISE” indicator 97. This is because the constant speed setpoint may be determined not by the current vehicle speed, but rather by the current target vehicle speed, which is related to the accelerator pedal position. Until the vehicle reaches the target vehicle speed, indicators such as the indicators 94, 96 will provide a mechanism by which the driver knows what the cruise control setpoint will be.

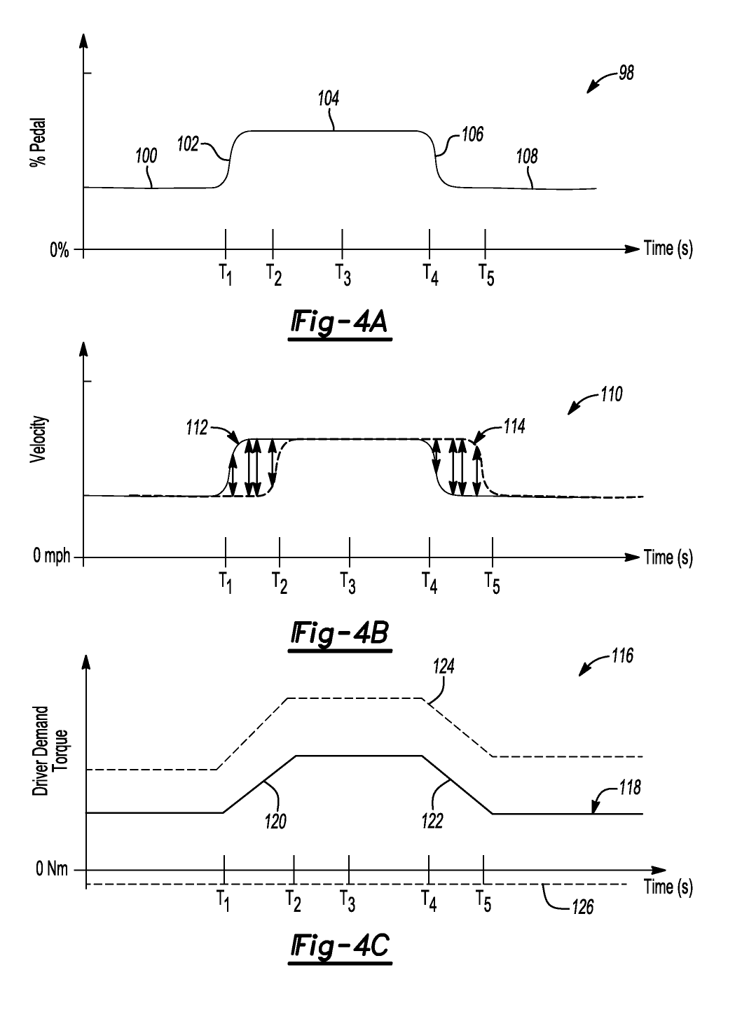

Turning to FIG. 4A, a graph 98 is shown, which indicates a change in accelerator pedal position over time. Specifically, from time 0 to t1, the pedal position is constant as indicated by the flat portion 100 of the graph 98. Then, at time t1, the accelerator pedal is deflected by the driver—i.e. there is a “tip-in”, as indicated by the increasingly-sloped portion 102. Once the driver reaches the desired pedal position, it is again held constant as indicated by the flat portion 104, generally shown between times t1 and t4. A tip-out occurs at time t4 as indicated by the decreasingly-sloped portion 106. The accelerator pedal is then again held constant by the driver as indicated by the flat portion 108. In accordance with embodiments of the present invention, the changes in accelerator pedal position shown in the graph 98 correlate to various changes in vehicle velocity and torque, which, as explained above, is controlled to achieve the target vehicle speed as determined by the accelerator pedal position.

The graph 110 shown in FIG. 4B shows changes in target velocity, as indicated by the solid line 112, and actual velocity, as indicated by the dashed line 114. As shown in the graph 110, the target velocity parallels the pedal position shown in the graph 98 in FIG. 4A. The actual velocity, however, lags behind the target velocity both when the pedal is tipped-in and when it is tipped-out. This is one reason that indicators, such as the indicators 94, 96 shown in FIG. 3, are so beneficial: during the lag between the time the target velocity is set via a change in accelerator pedal position and the time when the actual vehicle velocity reaches the target, the driver will have accurate information regarding the relationship between the newly chosen pedal position and the velocity the vehicle will achieve.

As described above, embodiments of the present invention may control the vehicle speed by controlling the wheel torque to ensure that the vehicle achieves the target vehicle speed. This is illustrated in the graph 116, shown in FIG. 4C. The solid line 118 illustrates changes in the driver demanded torque—which can be translated into a wheel torque—as the pedal position changes as shown in the graph 98 in FIG. 4A. In at least some embodiments, a PI controller is applied to a difference between the current vehicle speed and the target vehicle speed—respectively shown by the dashed line 114 and the solid line 112 in FIG. 4B. As the accelerator pedal is tipped-in and tipped-out—see the increasing and decreasing sloped portions 120, 122 of the line 118—the driver demanded torque changes, but more gradually than the change in pedal position or vehicle velocity. This is a function of the PI controller, and can be modified by modifying the controller or using different kinds of controllers, thereby achieving a faster or slower response. Thus, a controller, such as the PI controller, can be configured such that the vehicle speed is controlled to achieve the target vehicle speed based at least in part on a predetermined response schedule.

In at least some embodiments of the present invention, the relative time it takes to achieve the target vehicle speed—i.e., the predetermined response schedule—is preprogrammed into the vehicle control system and is not selectable by the vehicle operator. Conversely, in other embodiments, the predetermined response schedule is selectable by a vehicle operator from a plurality of available predetermined response schedules. For example, a gear shifter, such as the gear shifter 70 shown in FIG. 1, may be configured such that different modes of operation are selectable by a vehicle operator. For example, if the gear selector 70 is in the “Drive” position, a controller, such as the PI controller described above, may be set to achieve the target vehicle speed in what is considered a moderate, or reasonable, amount of time. This would be the same if the gear selector 70 were in the “Reverse” position, although there will likely be different velocity limits when the vehicle is in Reverse as opposed to when it is in Drive.

Another possible option for the vehicle operator would be to have a “Sport” mode, in which the gear selector 70 would be moved to the Sport position. In this position, the controller would be configured to crisply achieve the target vehicle speed in a shorter amount of time than would be the case if the gear selector 70 were in the Drive position. Another possible option is to have a “Fuel Economy” mode in which a button, which may be located for example on the gear selector 70, is pressed while the gear selector 70 is in the Drive position. In this mode, the controller would be configured to achieve the target vehicle speed in a longer amount of time, which would provide a fuel economy benefit, although it may also result in a less responsive feel on the accelerator pedal. Although the response schedules may be relied upon by the vehicle control system to help the vehicle achieve a target vehicle speed within a relative amount of time, other factors such as road conditions and the magnitude of the difference between the current vehicle speed and the target vehicle speed may be used in the control system. For example, even if the “Sport” mode is chosen, the vehicle control system may control vehicle speed to reach a new target vehicle speed if the road conditions are icy. Thus, the controller may control the vehicle speed based in part on a predetermined response schedule, but also based in part on other factors.

As described above, the driver demanded torque as indicated by the line 118 is a function of the difference in actual and target vehicle velocities shown in the graph 110 in FIG. 4B; however, it is also a function of certain wheel torque limits, as indicated by the dashed lines 124, 126 in FIG. 4C. Based on a number of factors, it may be desirable to limit the amount of wheel torque—either positive or negative—experienced by the vehicle regardless of what the driver demands by actuating the accelerator pedal. Thus, the wheel torque based on driver demand is clipped to an upper or lower predetermined limit if the driver demand would otherwise cause the wheel torque to be outside the predetermined limit. Although the lower torque limit shown by the line 126 in FIG. 4C is constant, the predetermined upper limit for the wheel torque shown by the line 124 changes as the accelerator pedal position changes. As shown in FIG. 4C, these changes generally parallel the changes in driver demanded torque, rather than following the much faster changes of the accelerator pedal position as shown in FIG. 4A. Therefore, the upper and lower torque limits can themselves be a function of accelerator pedal position.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for controlling a powertrain in a vehicle, comprising:
controlling vehicle speed around a plurality of target vehicle speeds based on respective accelerator pedal positions when the vehicle is operating outside of a constant speed control process; and
using the current target vehicle speed as a desired constant speed when the vehicle is operating within a constant speed control process.

2. The method of claim 1, further comprising indicating to a vehicle operator the current target vehicle speed and a current vehicle speed.

3. The method of claim 1, further comprising mapping accelerator pedal position to vehicle speed to facilitate generation of the respective target vehicle speeds based on the accelerator pedal positions.

4. The method of claim 1, wherein the vehicle speed is controlled to achieve one of the target vehicle speeds based at least in part on a predetermined response schedule.

5. The method of claim 4, wherein the predetermined response schedule is selectable by a vehicle operator from a plurality of available predetermined response schedules.

6. The method of claim 1, wherein controlling the vehicle speed includes controlling a wheel torque of the vehicle such that the wheel torque is clipped to a predetermined limit when controlling the vehicle speed results in a wheel torque beyond the predetermined limit.

7. The method of claim 6, wherein the predetermined limit is based at least in part on the accelerator pedal position.

8. A method for controlling a powertrain in a vehicle, comprising:
controlling vehicle speed based on differences between current vehicle speeds and corresponding target vehicle speeds based on respective accelerator pedal positions when the vehicle is operating outside of a constant speed control process; and
using the current target vehicle speed as a desired constant speed when the vehicle is operating within a constant speed control process.

9. The method of claim 8, further comprising indicating to a vehicle operator the current target vehicle speed and a current vehicle speed.

10. The method of claim 8, wherein the vehicle speed is controlled to achieve one of the target vehicle speeds based at least in part on a predetermined response schedule.

11. The method of claim 10, wherein the predetermined response schedule is selectable by a vehicle operator from a plurality of available predetermined response schedules.

12. The method of claim 8, further comprising mapping accelerator pedal position to vehicle speed to define a relationship between the vehicle speed and the accelerator pedal position.

13. The method of claim 8, wherein controlling the vehicle speed includes controlling wheel torques of the vehicle to achieve the target vehicle speeds, and further includes clipping the wheel torques to predetermined limits when controlling the vehicle speed results in a wheel torque beyond the predetermined limit.

14. The method of claim 13, wherein the predetermined limits are based at least in part on the accelerator pedal position.

15. A control system for controlling a powertrain in a vehicle, comprising:
a controller configured to continuously control vehicle speed around a plurality of target vehicle speeds based on respective accelerator pedal positions when the vehicle is operating outside of a constant speed control process, and to use the current target vehicle speed as a desired constant speed when the vehicle is operating within a constant speed control process.

16. The system of claim 15 further comprising a plurality of indicators, at least one of which is configured to indicate to an operator of the vehicle the current target vehicle speed and a current vehicle speed.

17. The system of claim 15, wherein control of the vehicle speed further includes controlling a wheel torque of the vehicle based at least in part on a difference between a current vehicle speed and the target vehicle speed.

18. The system of claim 17, wherein control of the wheel torque includes clipping the wheel torque to a predetermined limit when control of the vehicle speed results in a wheel torque beyond the predetermined limit.

19. The system of claim 18, wherein the predetermined limit is based at least in part on the accelerator pedal position.

20. The system of claim 15, wherein the controller is further configured to control the vehicle speed to achieve one of the target vehicle speeds based at least in part on a predetermined response schedule selectable by a vehicle operator from a plurality of available predetermined response schedules.
